(19) United States
(12) Patent Application Publication
(10) Pub. No.: US 2010/0217818 A1
(43) Pub. Date: Aug. 26, 2010

(54) MESSAGE REPLY AND PERFORMANCE EVALUATION SYSTEM AND METHOD THEREOF

(76) Inventor: CHAO-HUNG WU, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/771,150

(22) Filed: Apr. 30, 2010

Related U.S. Application Data
(63) Continuation-in-part of application No. 12/081,665, filed on Apr. 21, 2008.

(51) Int. Cl. G06F 15/16

(52) U.S. Cl. 709/206

(57) ABSTRACT

The present invention relates to a message reply and performance evaluation system, which are introduced into an electronic mail system. The message reply scheme has some control entries including a deadline for replying the message, an address for replying the message, and a field for verifying the reply. The performance evaluation scheme is provided for a sender performing evaluation corresponding to the replied message. As a sender transmits the message to a recipient, the email system of the sender will incorporate a message-to-reply field to the message. In addition, when the recipient receives the message, a reply field will be added to the email system after opening it. More, a reminder will be launched before the deadline. In particular, after receiving the reply, the sender may perform evaluation to the reply, and the evaluation will be recorded for future review.

### CROSS-REFERENCE TO RELATED APPLICATIONS

This application is a Continuation-in-Part of Application Ser. No. 12/081,665, filed on Apr. 21, 2008, and entitled MESSAGE NOTICE REPLY SYSTEM AND METHOD THEREOF.

### BACKGROUND OF THE INVENTION

1. Field of the Invention

The present invention relates to a message reply and performance evaluation system and a method thereof, and more particularly to a message reply scheme introduced in a message transmitting system to achieve the message reply and tracking effects and provide performance evaluation to the recipient after a job is dispatched.

2. Description of Related Art

In general, supervisors in a company usually deliver a job to their subordinates by transmitting messages through verbal expressions, written memos or emails However, busy subordinates may neglect the job delivered by their supervisor easily in the aforementioned method of dispatching jobs. Some supervisors may forget the job that they dispatch. Some supervisors are not sure whether or not their message is delivered properly, and some worry whether or not the job is done properly. Subordinates may forget or delay the job.

The traditional way of using e-mail for transmitting messages to remind an opposite party about some matters such as a sender specifies a “receipt request” function to request the recipient of an email when the sender sends the email to the recipient to assure that the recipient has actually received the email. The sender uses a mail user agent (MUA) to transmit an email through a mail transfer agent (MTA), wherein a receipt request command is bundled with the email, such that if the recipient uses the mail user agent (MUA) such as Outlook and Mozilla Thunderbird to open the mail, then a pop-up window can be used to notice the recipient whether or not to reply the e-mail.

The sender can further use e-mail software to generate a message notice, and sent the message notice in the form of an e-mail to the recipient, and the e-mail software used by the recipient produces an event of the calendar, so as to achieve the aforementioned purpose of delivering a job.

In addition to the traditional way of delivering a job as described in the prior art or using an improved prior art email function to provide an interactive way of delivering a job, the present invention further provides a message reply system and its method related to a message reply scheme for actively providing a reminder, and also creates a mail content including voice, image or handwriting content to give a more convenient and efficient message notice reply effect.

### SUMMARY OF THE INVENTION

In view of most job deliveries between people are done orally in person or through telephone, and the progress of the delivered job cannot be traced even if an e-mail or a mobile phone message is used for the same purpose, the present invention provides a message reply system and a method thereof, adding a message reply scheme to a general mail system, such that both sender and recipient can monitor the statues of processing and replying each mail, and also provide a message reminder function to assure that the mail recipients can execute the delivery job. Furthermore, since the job has been done, the sender is authorized to evaluate the performance to the recipient.

The message reply system of the invention comprises message sending means, waiting-to-reply means, message receiving means, a reply reminding means, replying means, acknowledge means and a performance evaluating means.

When the message sending means of the message agent sends a message in accordance with a preferred embodiment of the invention, a message reply control entry is added to the message. If the message is sent via an e-mail, then the mail user agent (MUA) connects to an outgoing mail server and transmits the e-mail to a receiving end after the sender is verified, and the message can be a text, a scanned document or a file including an audio/video document produced by an audio/video retrieving apparatus and attached to the message and a dynamic description produced by a handwriting system and recorded. Before sending the message, the waiting-to-reply means sets a time to reply the message, and after sending the message, the message agent adds a wait-to-reply field, and there are no particular limitations on the date, time, or recipient.

If the recipient uses the message agent to receive the message sent by an e-mail, then the mail user agent (MUA) will connect to an incoming mail server, and the e-mail will be received after the recipient is verified. After the reply reminding means analyzes the received message content by the message agent, the message is recorded in the message agent and a reply reminder field is added, and different forms of repeated reminders can be performed to the recipient with a specific deadline. If the recipient completes the job delivered by the sender or needs to reply to the sender, then the recipient will select a desired reply message, and use the message agent to send a reply message, wherein the message reply control entry is still attached, and the reply reminder field is recorded to show the completion of the reply, and the reply message can be a text, a scanned document, or a file including an audio/video document produced by an audio/video retrieving apparatus and attached to the message and a dynamic description produced by a handwriting system and recorded.

After the sender has received a reply message from the recipient and analyzed the message, the replying means records the message reply control entry information, and records the wait-to-reply field previously added by the message agent. In particular, there is a new field of evaluating performance added by the message agent as receiving the reply message. After that, the sender, may be a supervisor, may perform an evaluation immediately to the recipient as reviewing the job the he has done.

The message notice reply method of the invention comprises a message sending procedure and a message receiving procedure.

The message sending procedure comprises the step of starting a message agent to connect an outgoing mail server, adding a message reply control entry to a message created by a sender, transmitting the message to a recipient through the outgoing mail server, using the message agent to file a backup copy, and adding one or more wait-to-reply fields.

The message receiving procedure comprises the steps of connecting the incoming mail server to receive a message, analyzing the content of the message, filing the message, adding a reply reminder field. Then, a message reply procedure is carried out. The message reply procedure comprises the steps of connecting an outgoing mail server to send a reply message, and records the reply reminder field. Further, an acknowledge procedure comprises connecting an incoming mail server to receive the reply message, analyzing the reply message, and then recording the wait-to-reply field.

Furthermore, the message receiving procedure on the sender side may have a procedure of performance evaluation. When the message replied by the recipient is sent to the sender, a performance evaluation field will be added. The sender may then perform evaluation to the recipient. The evaluation may be sent out to database, and optionally to the recipient.

To make it easier for our examiner to understand the expected objectives, technical measures and effects of the present invention, we use preferred embodiments together with the attached drawings for the detailed description of the invention, but it should be pointed out that the attached drawings are provided for reference and description but not for limiting the present invention.

### BRIEF DESCRIPTION OF THE DRAWINGS

FIG. 1 shows the architecture of an e-mail system in accordance with the present invention;

FIG. 2A shows a screen of a sender end of a message reply system in accordance with the present invention;

FIG. 2B shows a screen of a recipient end of a message reply system in accordance with the present invention;

FIG. 2C shows a screen of a message agent in accordance with the present invention;

FIG. 2D shows a directory used by a message agent in accordance with a preferred embodiment of the present invention;

FIG. 2E schematically shows a window of a performance evaluation with an embodiment of the present invention;

FIG. 2F schematically shows a window illustrating a table of performance evaluation statistics with an embodiment of the present invention;

FIG. 2G schematically shows a window illustrating a table of performance evaluation report for each staff in accordance with the present invention;

FIG. 2H schematically shows a window illustrating a table of performance evaluation report for each staff in accordance with the present invention;

FIG. 2I schematically shows a window illustrating a function of performing performance evaluation for each staff using various methods in accordance with the present invention;

FIG. 3A shows a flow chart of the claimed method in accordance with the present invention;

FIG. 3B shows one more flow chart of the claimed method in accordance with the present invention;

FIG. 4A shows a flow chart of transmitting a message by a message reply system in accordance with the present invention;

FIG. 4B shows a flow chart of replying a message by a message reply system in accordance with the present invention;

FIG. 4C shows a flow chart of preference evaluation by a message reply system in accordance with the present invention;

FIG. 5A shows a flow chart of transmitting an audio/video message by a message reply system in accordance with the present invention;

FIG. 5B shows a flow chart of replying an audio/video message by a message reply system in accordance with the present invention;

FIG. 5C is a flow chart of performing performance evaluation in accordance with the present invention;

FIG. 6 shows a flow chart of transmitting a message by a message agent of a message reply system in accordance with the present invention;

FIG. 7 shows a flow chart of receiving a message by a message agent of a message reply system in accordance with the present invention;

FIG. 8 shows a flow chart of replying a message by a message agent of a message reply system in accordance with the present invention;

FIG. 9 shows a flow chart of replying a message by a message agent of a message reply system in accordance with the present invention; and

FIG. 10 shows a flow chart of a message reply system selecting a message creating method in accordance with the present invention.

### DETAILED DESCRIPTION OF THE PREFERRED EMBODIMENTS

The present invention is described in details by preferred embodiments together with attached drawings as follows:

The invention provides a message reply and performance evaluation system and a method thereof, wherein a message reply and performance evaluation scheme are particularly introduced into an e-mail system. In addition to the traditional job delivery between people, the invention provides the system and related method to not only trace the assigned job progress, but also authorize the assigner to perform the evaluation for each job.

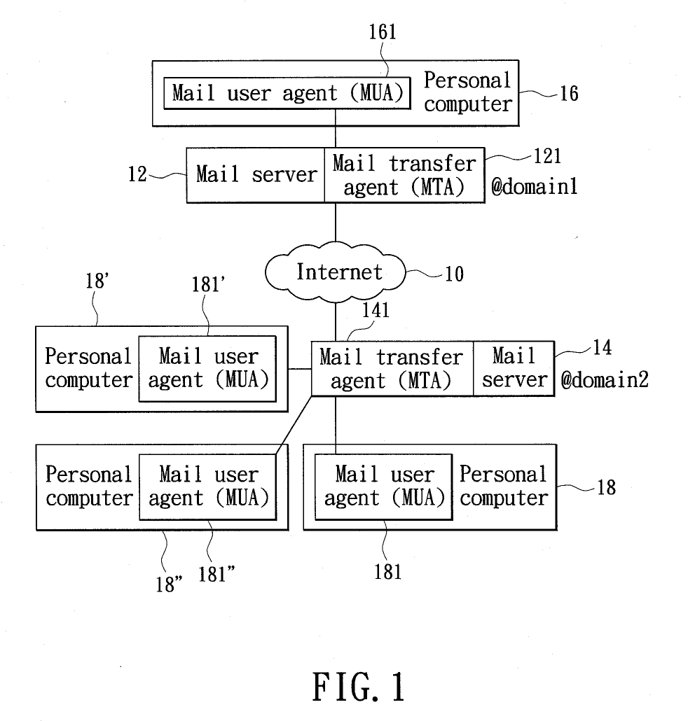

In the network environment of the Internet or a local area network (LAN), a system including a plurality of mail servers is used for transmitting e-mails. Referring to FIG. 1 for the network architecture of an e-mail system, a first mail server 12 and a second mail server 14 are connected separately to the Internet 10, and each has a domain name, such as domain1 for the first mail server 12, wherein a mail transfer agent (MTA) 121 establishes the mail service of @domain1, and domain2 for the second mail server 14, wherein the mail transfer agent (MTA) 141 establishes the mail service of @domain2.

A plurality of computers used by users are connected directly or indirectly to the Internet 10, or directly connected to a personal computer 16 of the first mail server 12, and connected to personal computers 18, 18′, 18″ of the second mail server 14 as shown in FIG. 1, and each personal computer installs a mail user agent (MUA) such as Outlook, Mozilla Thunderbird and different mail sending and receiving software supporting different operating systems for receiving e-mails. In FIG. 1, users need to use a mail user agent (MUA) 161 installed in the personal computer 16 to transmit or receive e-mails, and a user at an opposite end can use a mail user agent (MUA) 181 installed in the personal computer 18, a mail user agent (MUA) 181′ installed in the personal computer 18′ or a mail user agent (MUA) 181″ installed in the personal computer 18″ to receive or transmit e-mails.

The message reply and performance evaluation system in accordance with a preferred embodiment adopts e-mails for its process, but the procedures including the preparation, transmission and receipt and reply of messages are necessary to be transmitted via e-mail, since a specific proxy program can be used to achieve the specific communication protocol. Particularly, the reply software program for creating audio/video can maximize the utility of the functions of the message reply and performance evaluation system. In addition to a general mail communication protocol, a peer-to-peer method can be used for the transmissions. The message agent of the mail user agent (MUA) introduces a message reply scheme, and the message notice in accordance with a preferred embodiment of the present invention can be a job delivered by a superior to a subordinate or among colleagues or friends.

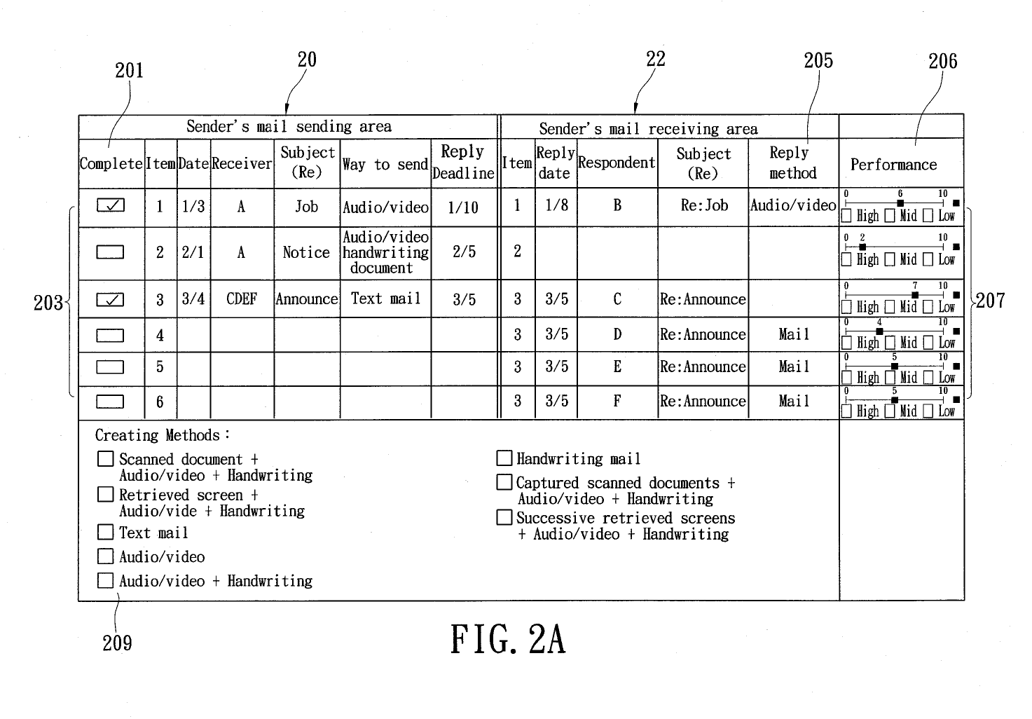

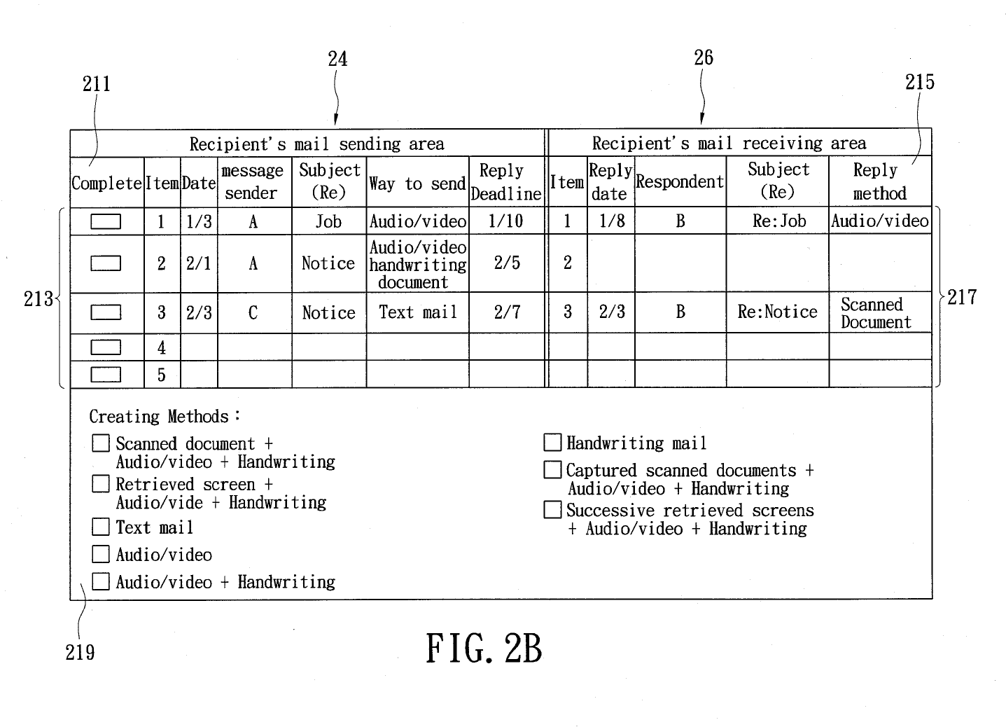

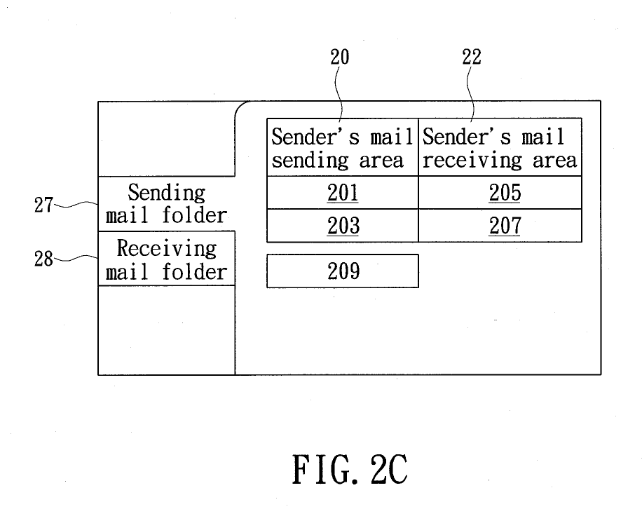

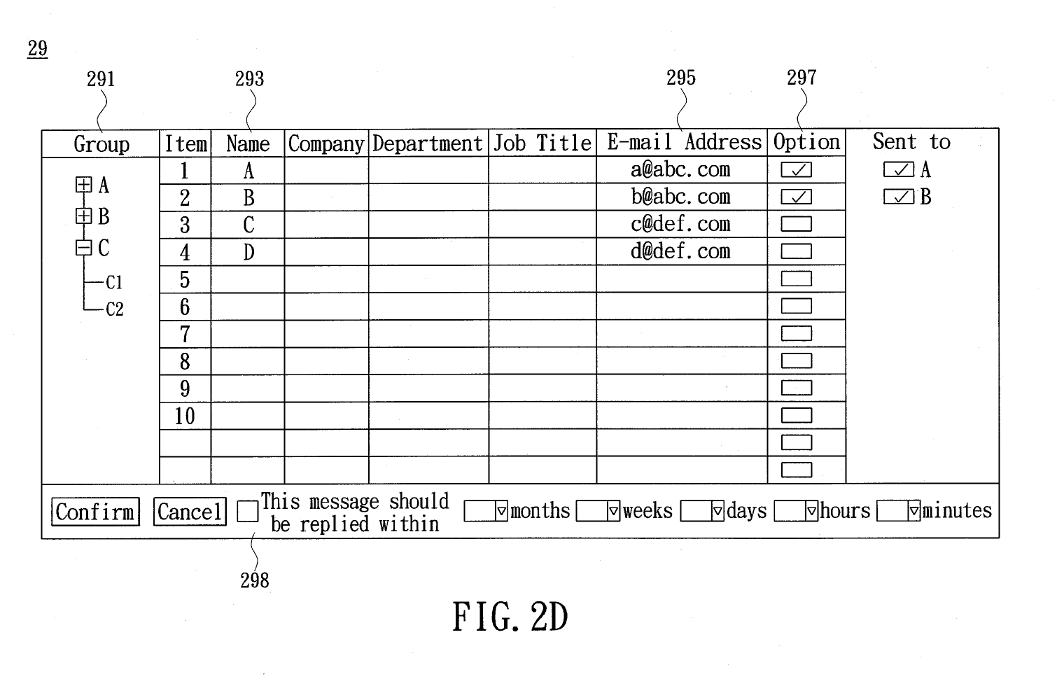

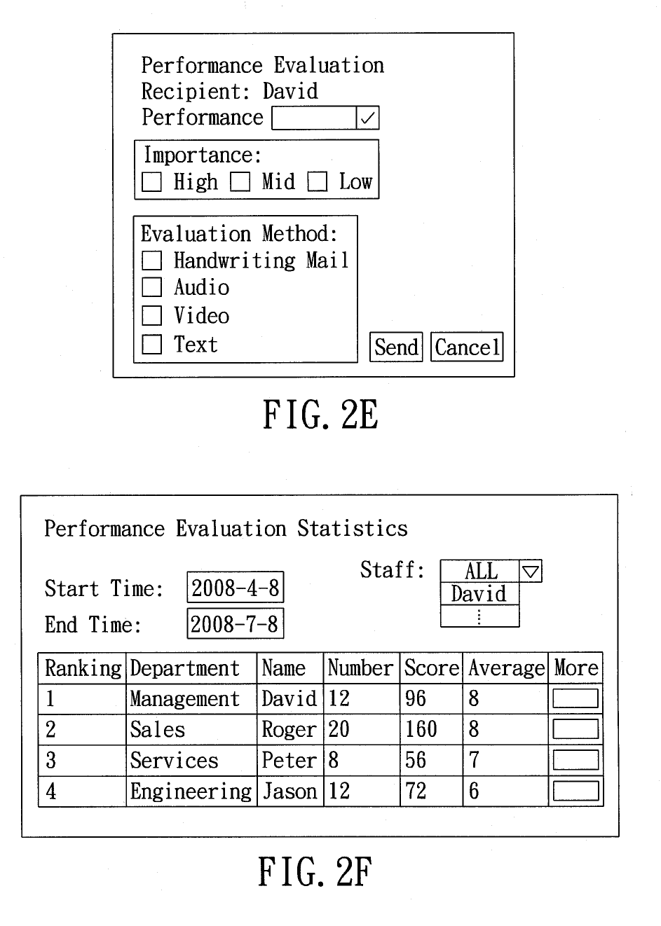

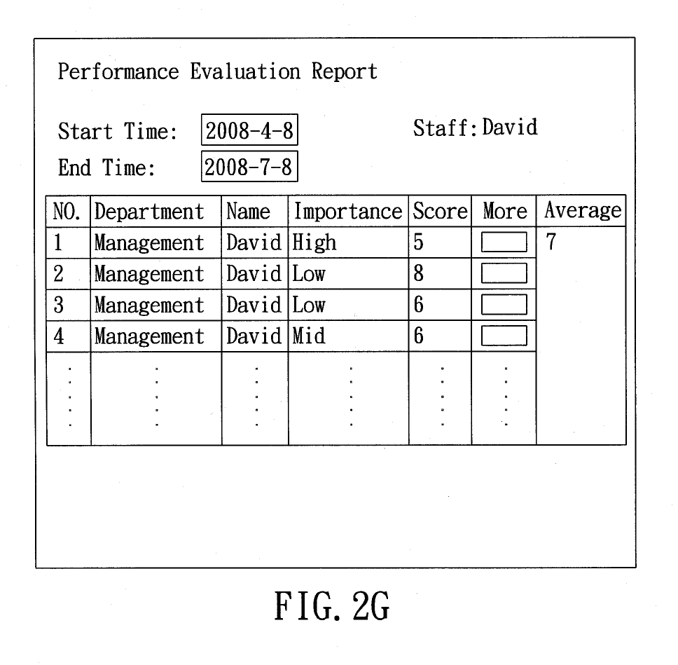

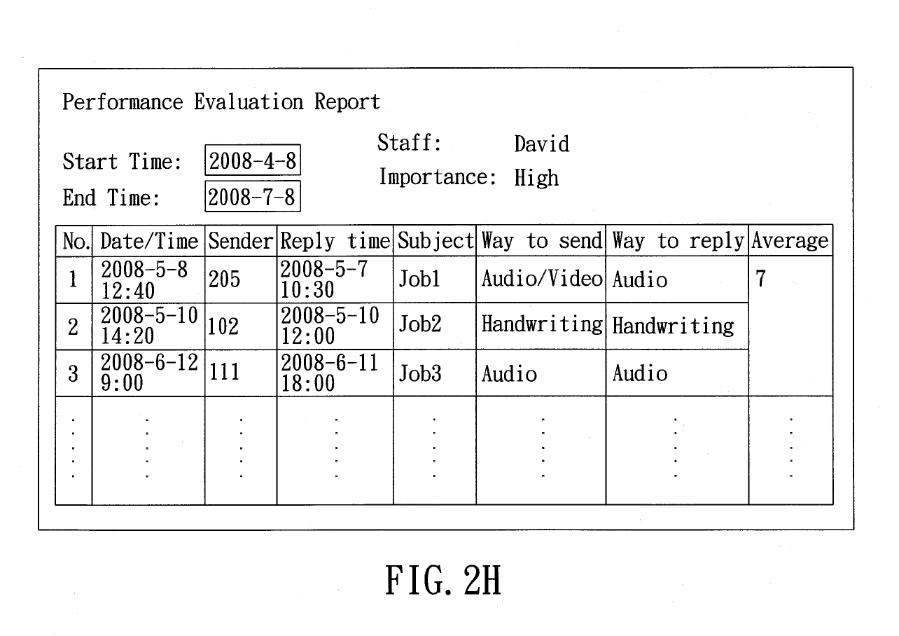

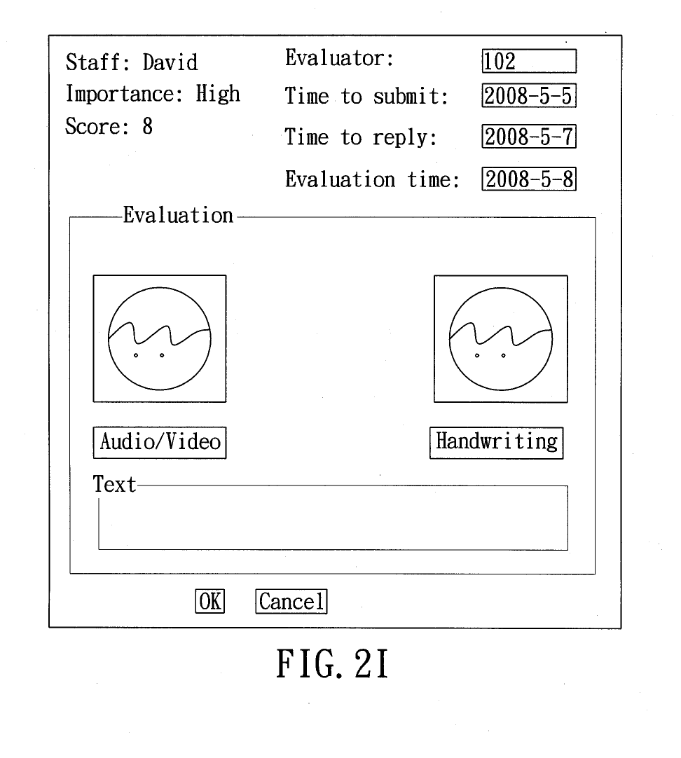

Reference is made to FIG. 2A for a screen of a sender end of a message reply system in accordance with the present invention. The screen of a sender end of the message agent comprises two areas, respectively a sender's mail sending area 20 and a sender's mail receiving area 22, wherein the sender's mail sending area 20 includes a mail sending area field 201 and a message content list 203 comprised of information such as date/time, message recipient, subject, way to send, and time to reply. After a sender sends out a message, the sender can use the message agent to automatically set a default message subject, or manually create the message subject, and set the time to reply the message, wherein the time to reply is converted into a reply date after the time to reply is set to a few hours, a few days or a few weeks. The foregoing setup result and the date/time and sender of the transmitted message will be displayed automatically in the message agent field.

Further, the above information can be sent by an audio/video, an audio/video handwriting document or a text mail, and the way to send is displayed in a creating method field 209 which includes a message produced by a scanned document or a retrieved screen, a message produced by an audio/video, a handwriting message, a pure text message, and a message produced by capturing a plurality of scans and a message produced by retrieving successive screens, and the aforementioned methods can be combined freely to produce a message, such as a mail produced by “scanned document or retrieved screen+audio/video+handwriting” or a mail simply produced by a “scanned document or a retrieved screen” or an “audio/video mail” produced by an audio/video preparing equipment” or a mail including “audio/video+handwriting mail” in its production or a “handwriting mail” carried out by a handwriting panel, or a mail combined with “handwriting+audio/video”, such that the sender can produce different e-mails quickly by clicking a desired option, and needs to comply with each hardware equipment including an audio/video device, a handwriting panel and a scanner, etc.

More specifically, the mail is sent for the first time according to a method in the creating method field 209, and the record of sent message data is generated in the sender's mail sending area 20, but the mail is sent for the second time and thereafter by clicking any record of the message or any replied and received record of message in the sender's mail sending area 20 or the sender's mail receiving area 22, and then selecting a creating method in the creating method field 209 to complement the message for the second time, third time, fourth time to n^{th} time. Thus, a sent reply time is not just for a one-to-one correspondence record only, but also for many sent or replied records. Further, the sender can select an option whether or not to complete the message (and the default setting is set to be not to complete), so that we can check the messages of all incomplete jobs.

Another area is provided for displaying the sender's mail receiving area 22, which comprises a mail receiving area field 205 and a message content list 207 including reply date/time, respondent, subject, and type of reply. After the message sender has transmitted a message, and set its time to reply (the time to reply or the person to reply may not set), a “wait to reply field” and a “performance evaluation field 206” are added in the sender's mail receiving area 22 and displayed at a side of the corresponding transmitted message to record the reply message. As the second row of the sender's mail receiving area, the “performance evaluation field 206” may also be shown as sending the message, but before receiving the reply. Therefore, the sender may perform the evaluation before receiving the reply since the time limit set for the reply is met. In addition to the messages recorded in the aforementioned message content list 203 of the sender's mail sending area 20, the added sender's mail receiving area 22 is comprised of the mail receiving area fields 205 and the message content list 207. Further, a reply reminder is generated within a specific time according to the message of the wait to reply field. Still further, the performance evaluation field 206 is provided for the sender, may be a supervisor of the recipient, to perform evaluation on each message the recipient have replied and the job the recipient have done.

In the embodiment as shown in the figure, the sender's mail sending area 20 records that a recipient B sent a message with a subject “Job” on Jan. 3, and set the time to reply as Jan. 10; and another person sent a message with a subject “Notice” to the recipient B on Feb. 1 and set the time to reply as Feb. 5, and sent a message with a subject “Announcement” to several recipients C, D, E, F. Further, the sender's mail receiving area 22 records that the recipient B sent a reply message with a subject “Re: Job” (which is automatically generated by adding the retrieved original subject of the received message behind the reply (Re:)) to the sender A (wherein it is not necessary to display the sender A on the screen) on Jan. 8 to reply the message sent by the sender A, and the reply is made in the form of an audio/video message. In addition to the main reply method by using audio/video contents, another preferred embodiment can use a text message, and the sender's message can be transmitted simultaneously to a plurality of recipients. Now, the recipient field may show a plurality of recipients, and the corresponding fields will indicate a plurality of employee reply fields, so that each reply status can be traced easily. Each of the field contents can be opened by clicking with a mouse or any other pointing device, and the screen display facilitate users to trace each reply message. In another preferred embodiment, if the time to reply of the sender end is met, but no mail is replied yet, then the program will automatically generate a number of times of the reply reminders, and such reply reminders will be shown automatically on a computer screen or dialed automatically to a preset telephone or mobile phone through the function of a VoIP to provide an effective reminder automatically.

In this preferred embodiment, the sender can click the message in the sender's mail sending area 20 again to resend the already transmitted message to other persons and set the time to reply. Further, the sender may also use a score bar or the other similar tools displayed in the performance evaluation field 206 to score the recipient. Optionally, the performance evaluation field 206 may have some checks, including high, mid and low, for the sender checking to indicate how important to the job. According to this evaluation scheme, the evaluation is effectively directed to the job at the time the job has been done. It is worthy noting that the immediate performance evaluation may exactly indicate the performance, and exclude the later unfair evaluation based on the sender's unreliable feelings.

Now, the message content list 203 in the sender's mail sending area 20 produces a record of the sent message, and displays each sent message according to the sending order. Similarly, if the recipient end repeatedly makes a reply, the sender's mail receiving area 22 of this embodiment will produce a record of the reply message in the message content list 207 again, and display each reply message according to the reply order.

Referring to FIG. 2B for a screen of a recipient end of a message reply system in accordance with the present invention, the message agent comprises two areas, respectively a recipient's mail receiving area 24 and a recipient's reply area 26, wherein the recipient's mail receiving area 24 comprises a mail receiving area field 211 consisting date/time, message sender, subject, way to receive, and time to reply, and the information of the received message is displayed at the message content list 213.

After the message is received, the message agent will analyze the message content to display the information of the message such as the field contents of date/time, message sender, subject, way to receive, and time to reply, etc. If the message is a message with an attached message reply control entry, then the recipient's reply area 26 will add the a reply area field 215 (comprising the fields of reply date/time, respondent, subject and reply method) corresponding to the message, and produce a corresponding message in the message content list 217 after the reply is made.

In this preferred embodiment, the sender also can click a message in the recipient's mail receiving area 24 to send the already replied message to the original sender. Now, the message content list 217 in the recipient's reply area 26 will produce another record of reply message, indicating that the reply has been made for several times, and each message is displayed according to the reply order. In the same time, if the recipient end receives such reply message repeatedly, the mail receiving area also displays another record of reply message. In the embodiment as shown in the figure, the recipient receives the “Job” message sent by the sender A on Jan. 3 and learns from the message content that the time to reply is Jan. 10, since this message has set the time to reply, and thus a “reply reminder field” is added and displayed at a side of the corresponding received message, for recording a required reply message, similar to the aforementioned recipient's reply area 26 comprised of the reply area field 215 and the message content list 217. Further, a reply reminder (displayed on the screen, or dialed to a telephone or mobile phone through a network by an integrated VoIP technology) is produced (repeatedly) in a specific time according to the message of the reply reminder field, and the way to receive including an audio/video, an audio/video handwriting document, and a text mail is recorded.

In the embodiment as shown in the figure, the sender A sent a message with a subject “Notice” on Feb. 1 and set the time to reply as Feb. 5, and received a “Notice” message sent by a sender C on Feb. 3 and a set time to reply on Feb. 7.

However, after the recipient has received a reply message of the sender, the recipient's reply area 26 has recorded the reply message. In the embodiment as shown in the figure, the message content list 217 records that the recipient B replied a reply “Re: Job” message on Jan. 8, and the way of replying the message is by an audio/video document, or by a text reply in accordance with another preferred embodiment. Further, it is recorded that the reply message “Re: Notice” is sent by the recipient B on Feb. 3, the way of replying the message is by a scanned document.

When the reply is made, it is necessary to click any one of the records in the message recipient's mail receiving area 24 first, and use the creating method field 219 to select a way of producing the reply message, which includes a message produced by a scanned document or a retrieved screen, an audio/video message, a handwriting message, a pure text message, a message produced by capturing a plurality of scans, a message produced by retrieving successive screens, and a message produced by any combination of the above such as a mail produced by the “scanned document or retrieved screen+audio/video+handwriting’ or a mail simply produced by a “scanned document or a retrieved screen” or an audio/video mail prepared by an audio/video apparatus or an “audio/video+handwriting mail” produced by a handwriting panel, or an integrated “handwriting+audio/video” mail, so that the sender can produce different e-mails quickly by clicking a desired option, and the sender has to comply with each hardware equipment including an audio/video device, a handwriting panel and a scanner, etc. More specifically, when the reply is made, several copies of the replies can be duplicated to any record of the received message item in the same recipient's mail receiving area 24, so that users can complement any missing description of the reply anytime.

In the reply mechanism in accordance with the foregoing preferred embodiment, a message reply control entry is introduced to the transmitted message, and the information comprises control entries such as time to reply, reply address and wait/reply reminder field. If the message is transmitted from the sender, the message agent at the message sender end will add one or more wait-to-reply fields, wherein the date/time, or reply person is not restricted, and the message reply control entry is attached to the message, and the wait to reply field is recorded, and the recipient's reply message is displayed as shown in FIG. 2A.

After the recipient end receives and opens the message, the message agent at the recipient end adds a reply reminder field according to the attached control entry information, wherein the recorded contents are listed in a screen of the recipient end as shown in FIG. 2B, and a reminder is issued to the recipient within the recorded deadline (which is a default setting or a period such as three hours or a day set by users). After the recipient end has replied the message, the reply is recorded in the reply reminder field, which will be converted into a reply date automatically, and at least record the reply date/time. After the sender end has received the reply message, the attached message (such as the message reply control entry) is recorded into the wait-to-reply field according to the message attached to the reply message, and at least the reply date/time is recorded, so as to achieve the purpose of replying to a message after a job is delivered.

The aforementioned message reply system can further transmit an audio/video document produced by the audio/video retrieving apparatus, and the handwriting system. After the recipient end has received the audio/video document, the aforementioned message reply mechanism is provided for replying an audio/video message. In addition, the message agents of the sender and the recipient in accordance with this preferred embodiment are mail user agents (MUA), and the transmitted and received messages are in the form of e-mails, and the devices used by both of them are desktop computers or notebook computers or other portable communication devices including personal digital assistants (PDA) and mobile phones, etc. Further, the sender end can transmit the foregoing message to the recipient end at the same time, and the recipient end can have a plurality of recipients.

The message reply system in accordance with the present invention comprises the aforementioned mail sending and receiving functions integrated in the message agent as shown in FIG. 2C, and the program comprises a sending mail folder 27 and a receiving mail folder 28, wherein the functions include using a message agent to achieve mail sending means and mail receiving means, such that the sending mail folder 27 or the receiving mail folder 28 can be browsed by switching a computer cursor (or a mouse cursor or a keyboard control), and the display method is not limited those illustrated in the figure, but also includes other required mail sending and receiving functions of an e-mail system.

In a preferred embodiment as shown in FIG. 2C, a sending mail folder 27 displayed on the screen of the send end as shown in FIG. 2A comprises two areas, respectively a sender's mail sending area 20 and a sender's mail receiving area 22, and the sender's mail sending area 20 includes a mail sending area field 201 and a message content list 203, and the sender's mail receiving area 22 has a mail receiving area field 205 and a message content list 207, and several creating methods 209 displayed in accordance with a preferred embodiment include the foregoing “scanned document or retrieved screen+audio/video+handwriting”, “scanned document or retrieved screen”, “text mail”, “audio/video mail”, “audio/video+handwriting mail”, “handwriting mail”, “captured scanned documents+audio/video+handwriting”, “successive retrieved screens+audio/video+handwriting” and “handwriting+audio/video mail’, etc.

FIG. 2D shows a directory used by a message agent in accordance with a preferred embodiment of the present invention, and if it is necessary to produce a message, the name list of recipients in the directory 29 can be used for the selection, and the recipients can be divided into groups 291 to facilitate their search and display, and each group 291 displays its respective fields such as name 293 and e-mail 295, etc. The select field 297 is provided for selecting one or more recipients, and after the selection is completed, a reply deadline can be set in the deadline setup field 298, such as a few hours, a few days or a few weeks, and the program will automatically convert the reply deadline into date and time for the display.

More particularly, the message agent provides a function of performance evaluation for every replied job. Referring to FIG. 2E, which schematically shows a window of performance evaluation with an embodiment of the present invention. While the sender selects the message sent from the recipient, a window may be shown up for more detailed evaluation. The window displays the performance evaluation to the recipient David in one exemplary method in accordance with the invention. David's supervisor, the sender in the current case, may select a score for the performance, and check one selection selected from high, mid and low to express how the importance is. When the sender gives the response to the recipient, he may use one of the evaluation methods, including handwriting mail, audio, video, text mail and their combination, to provide his detailed evaluation in addition to the above mentioned evaluation scheme.

When the evaluation has been done, the related record is preferably filed in a database. In one exemplary example, the content in the database is referred to evaluate the employees in one company for a period of time. It is beneficial for the company's performance since it provides a just evaluation mechanism for the employees, but not the prejudice. FIG. 2F schematically shows a window illustrating a table of performance evaluation statistics, which is referred to make the evaluation of any staff.

After collecting the performance evaluations for the employees or any people in the database, the performance evaluation statistics shown in FIG. 2F can be created. It sets a start time, an end time and all or any staff to be listed. The table shows the ranking, departments, names, numbers, scores and averages for several people. The button “More” assists the viewer in browsing more information for each record than the current shown fields. According to the records in the database, it is effectively, fairly and convenient to have the statistics like the table.

Furthermore, in FIG. 2G, which shows a performance evaluation report having records for any one or more staffs selected from the above mentioned list. The table shows at least information including department or division, staff name, importance, score, average, and more. The button “More” assists the viewer in seeing more information with respect to the one selected record. The shown information is not limited to the information to be listed in accordance with the present invention.

Further, FIG. 2H shows a next window illustrating a table of “High” importance of the performance evaluation report within a specific time period for the staff “David”. This table assists the supervisor to review the performance of David as the submitted job categorized as “High”. That brings a feature to overlook any staff's performance by means of various filtering conditions.

When the authorized viewer selects one of the jobs listed on the table, such as the tables shown in FIGS. 2F, 2G and 2H, a window schematically shown in FIG. 2I will be popped up. This window illustrates a function to review a specific job or event with performance evaluation for one staff. The window includes information for the viewer clearly to check that event. The information preferably includes the name of staff, the evaluator, the importance for the job, score, the information of time to submit, time to reply, and evaluation time. Further, besides the viewer may see every detail regarding the event, the viewer may still add further evaluation on it using the various methods.

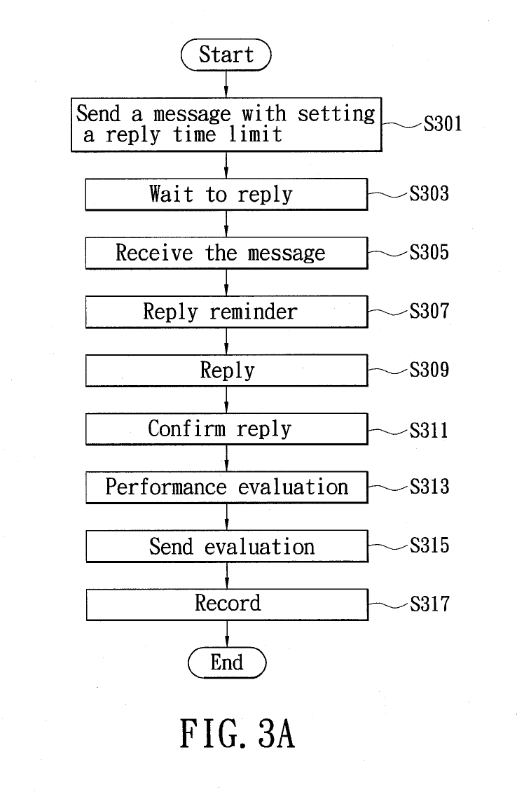

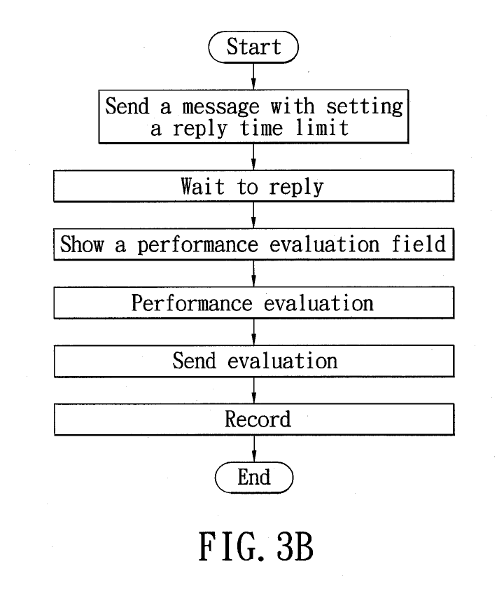

FIG. 3A shows a flow chart of a method applied to the claimed message reply and performance evaluation system. The message reply and performance evaluation system of the invention introduces the foregoing message agent to the message reply mechanism, and includes a plurality of functional means as described below:
1. (Step S301) A message is created and sent with setting a replay time limit. That is, when the message sending means uses a message agent to send the message, a message reply control entry is attached to the message. If the message is in the form of an e-mail, then a mail user agent (MUA) connects to an outgoing mail server. After the sender is verified (and the verification is not a must), the e-mail is sent to a receiving end, and the message can be a text, a scanned document or a file including an audio/video document produced by an audio/video retrieving apparatus and attached to the message and a dynamic description produced by a handwriting system and recorded.
2. (Step S303) Before the waiting-to-reply means sends out the message, a time to reply the message is set. After the message is set, one or more wait-to-reply fields are added to the message agent, and the wait to reply fields are displayed on a side corresponding to the message.
3. (Step S305) The recipient receives the message by the message agent. If the message is in the form of an e-mail, then a mail user agent (MUA) connects to an incoming mail server, and receives the e-mail after the recipient is verified.
4. (Step S307) The reply reminding means records the message into the message agent after the message agent analyzes the received message content, and then a reply reminder field is added to remind the recipient to reply within a specific deadline (and the reminding method includes using the VoIP technology for the reminder), and the reply reminder field is displayed at a side corresponding to the message.
5. (Step S309) When the recipient completes the job delivered by the sender or other required replies, the recipient selects a desired reply message first, and sends a reply message by the message agent, wherein the message reply control entry is attached, and the reply reminder field is recorded to indicate the completion of a reply. The reply message can be a text, a scanned document or a file, including an audio/video document produced by an audio/video retrieving apparatus and attached to the reply message, or a handwriting dynamic description of the reply message produced by the handwriting system;
6. (Step S311) Confirm that the replying mean records the information of a message reply control entry after the sender has received the recipient's reply message and analyzes the information recorded in the message. Then a wait-to-reply field is added to the message agent before being recorded.
7. (Step S313) A performance evaluation field is also added to the message agent. After reviewing the job the recipient has done, the sender may perform an evaluation with regard to current job. For example, the message agent provides a pull bar for the sender to adjust the value, or a field to fill the score. Further, the sender may also attach any note with the evaluation. In which, the performance evaluation is attached with a note selected from a handwriting message, audio message, video message, text message or their combination.
8. (Step S315) After the sender completes the evaluation, the evaluation will be sent out. Optionally, the recipient or any other supervisor may receive the evaluation.
9. (Step S317) The evaluation will be recorded in a database.

The above procedure can be repeated. In other words, if a message is replied, a message reply control entry can be attached to the reply message, or a reply deadline is set after the original sender has received the reply message, so that the message notice reply method can be used repeatedly to achieve the purpose of replying and completing the delivered job.

One more flow chart of an embodiment in accordance with the present invention is shown in FIG. 3B.
1. (Step S321) A message is created by a sender, such as the recipient's supervisor or anyone who is in charge of the current submitted job. In particular, the message is with setting a reply time limit. When the message agent is employed to send the message, a message reply control entry is attached to the message.
2. After the sender is verified, the e-mail is sent to a receiving end. Then a time to reply the message is also set. One or more wait-to-reply fields are then added to the message agent, and the wait to reply fields are displayed on a side corresponding to the message (Step S323).
3. (Step S325) In one embodiment, the sender's end message agent will add a performance evaluation field for each event as sending out the message. Before receiving any replay, the sender may perform the evaluation on the case.
4. (Step S327) Within the time limit set to the message, one or more reminders will be displayed to the recipient at the receiving message agent. With respect to the time limit set to the message to the recipient, the recipient may ignore the reminder, or may not finish the submitted job on time, and the sender can perform a performance evaluation in the meantime. However, the sender may again perform the evaluation to replace the previous evaluation. Since the performance evaluation recorded in a the database is replaceable, the performance evaluation may be replaced by the later performance evaluation performed by the sender after reviewing the job when the recipient has done. Further, the sender may also attach any note with the evaluation.
5. (Step S329) After that, the evaluation will be sent to the recipient or any one who may concern.
6. (Step S331) The evaluation will be recorded in a database.

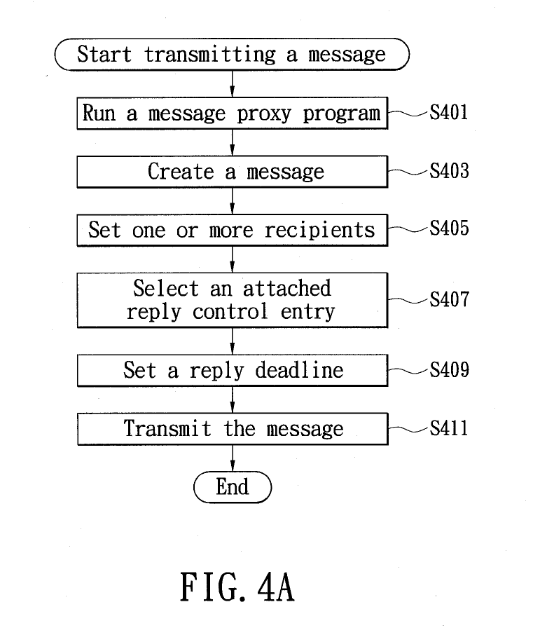

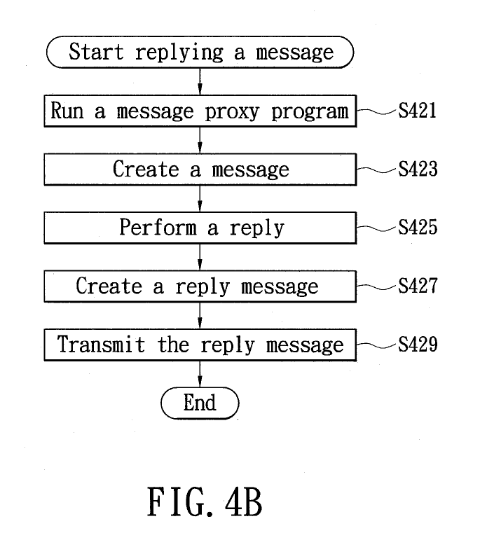

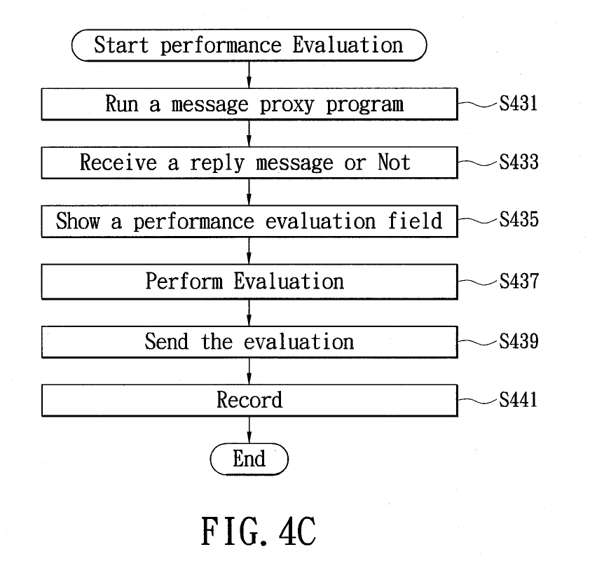

The message reply system of the invention is illustrated in details by the following embodiments, such as the message transmitting procedure as shown in FIG. 4A.

The invention uses a message agent such as a mail user agent (MUA) in a computer system for transmitting a message. In the beginning, a sender turns on a message agent (Step S401), and uses an editing program to create a message, and inputs the required notice items. (Step S403), and sets one or more recipients (Step S405), and selects a message reply control entry to be attached. In this step, the sender can either select or not to select a recipient reply message. If the sender decides not to select the recipient reply message, then the default setting of not to reply can be adopted (If it is necessary to set a reply message in Step S407, the sender has to set the time to reply, and the time to reply can be inputted manually or a predetermined time in a menu can be selected (Step S409), and then transmitted. If the mail user agent (MUA) is used for transmitting the message, then it is necessary to transmit the message to the recipient through an outgoing mail server (such as a MTP server) (Step S411).

FIG. 4B shows a flow chart of replying a message by a message reply system in accordance with the present invention. After the procedure of the flow chart is operated for receiving a message from the sender, the message agent such as a mail user agent (MUA) in a computer system is used for replying the message. At the beginning, the recipient turns on the message agent (Step S421), and then selects a desired reply message (Step S423) and sends the reply, wherein the related message reply control entry is still attached to the message (Step S425), or after the reply is completed, a reply message is created first (Step S427) and then transmitted (Step S429).

In addition to the described message reply scheme, the invention further provides a mechanism of performance evaluation. FIG. 4C shows a flow chart of the steps of performance evaluation. The performance evaluation scheme is provided for the sender to evaluate the replier, who is the person operating the assigned job. By means of the performance evaluation, the current performance may be revealed.

In step S431, a message proxy program is executed. One sender receives a reply message via a message agent (step S433). It is worth noting that, according to another embodiment, the sender may perform the evaluation even before receiving any reply from the recipient since a time limit is met. Currently, in the program, a performance evaluation field corresponding to the replied message is shown (step S435), however, the performance evaluation field may be shown at the moment of sending the message. The sender then performs evaluation (step S437). In an exemplary example, the performance evaluation field provides a column for the sender to fill in score for each job. Other alternative ways may not be limited in the invention. After that, the evaluation is sent out (step S439). The evaluation, meanwhile, will be recorded in the database (step S441).

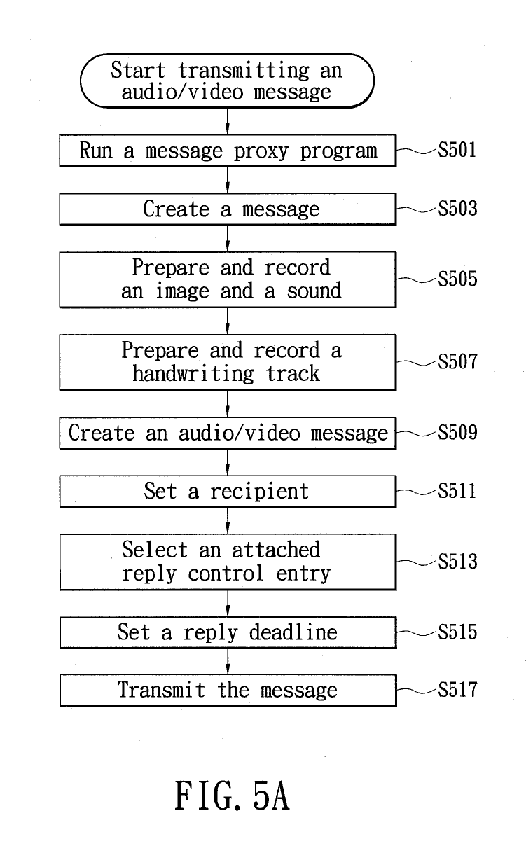

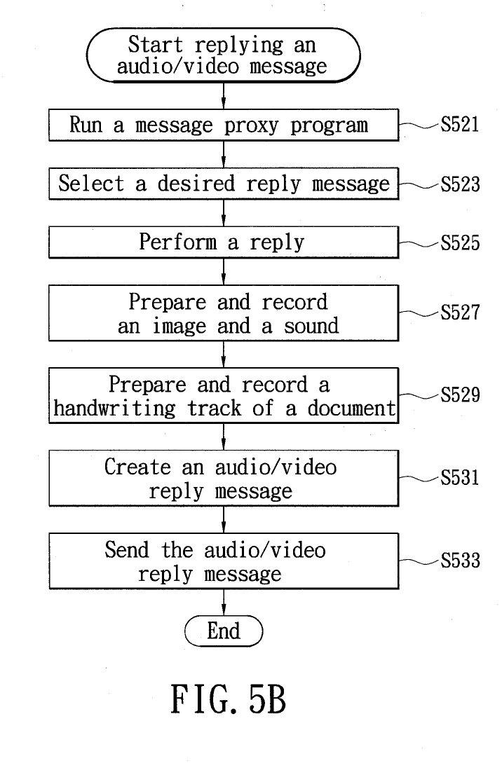

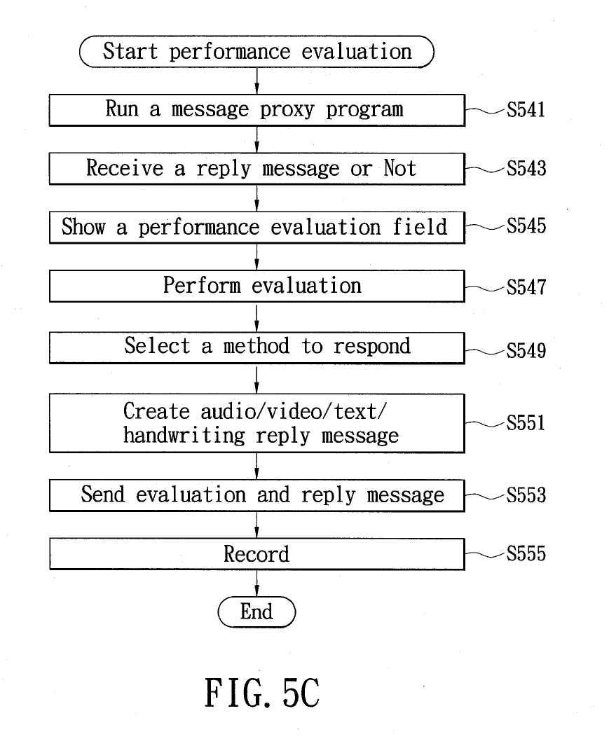

The aforementioned mail sending and replying processes use the message agent for transmitting the message. When it is necessary to create a desired sending message, the invention further uses an image capturing device, a sound capturing device, a document scanner, or a handwriting device to create the desired sending message as illustrated by in the flow chart of sending an audio/video message by a message reply system of the invention as shown in FIG. 5A.

The invention transmits a message by the message agent such as a mail user agent (MUA) used by a computer system in accordance with a preferred embodiment of the invention. At the beginning, the sender turns on the message agent (Step S501), and creates a message (Step S503) such as a message containing images and sound produced by an image capturing device and a sound capturing device including a camcorder in addition to a general document (Step S505), and a handwriting description of a handwriting track can be added to a general document or a scanned document (Step S507), and the foregoing images, sound, documents and handwriting description are integrated to produce an audio/video message (Step S509), and the audio/video message in this preferred embodiment is created by the audio/video document method disclosed by R.O.C. Pat. Application No. 93130138 entitled “Network audio/video document facsimile device and synchronous classified filing method” and filed by the inventor of the present invention on Oct. 5, 2004.

Then, a recipient is set (Step S511), and a message reply control entry is selected to be attached. In this step, the sender can select whether or not to have a recipient reply message (Step S513). If a reply message is required, then the time to reply is set, and the time to reply can be inputted manually or by selecting a preset time on a menu (Step S515), and then transmitted (Step S517).

FIG. 5B shows a flow chart of replying an audio/video message by a message reply system in accordance with the present invention, the invention not only allows the sender to send an audio/video document, but also allows the recipient to reply by an audio/video document. At the beginning, the recipient turns on a message agent (Step S521), and selects a desired reply message from a message list, (Step S523), and makes a reply by executing a reply function in the message agent (Step S525), and then prepare an image and sound by an image capturing device and a sound capturing device in addition to a general document (Step S527), and records a handwriting track on the general document or scanned document (Step S529), and the foregoing images, sounds, documents and handwriting contents are integrated to produce an audio/video reply message (Step S531). Similarly, and the audio/video message in this preferred embodiment is created by the audio/video document method disclosed by R.O.C. Pat. Application No. 93130138 entitled “Network audio/video document facsimile device and synchronous classified filing method” and filed by the inventor of the present invention on Oct. 5, 2004. After the audio/video reply message is created, the message agent automatically attaches the message reply control entry, and the message agent is used for transmitting the audio/video message (Step S533).

Further reference is made to FIG. 5C. A message agent is required to run performance evaluation in accordance with the present invention as a message proxy program is executed (step S541). After linking the incoming mail server, which is used to forward the message, the message agent is able to receive a reply message (step S543). A performance evaluation field is shown (step S545). However, it is also featured that, according to another embodiment, the sender may perform the evaluation anytime, even before receiving any reply from the recipient since a time limit set to the message is met. The sender may perform evaluation to the corresponding message (step S547). Alternatively, if the recipient does not reply the message by time, it means the submitted job may be failed or delayed, the sender may perform the evaluation for this kind of situation. After that, if the recipient replies the message, the sender may perform evaluation, and the previous record may be replaced.

Besides the evaluation, the sender may attach any note to the recipient. In the meantime, the message agent may show up some selections for the sender deciding a way to respond. Referring to FIG. 2E, the selection can be handwriting mail, audio message, video message or a text message. That means the performance evaluation sent by the sender may include an audio/video document produced by an audio/video retrieving apparatus or a dynamic description produced by a handwriting system.

While one of the methods to respond is selected (step S549), the sender may create an audio message, a video message, a text message, a handwriting reply message, or the message in combination of the methods. The multimedia reply message can be attached with the evaluation. After that, the evaluation and reply message is sent out (step S553), and recorded in the database (step 555).

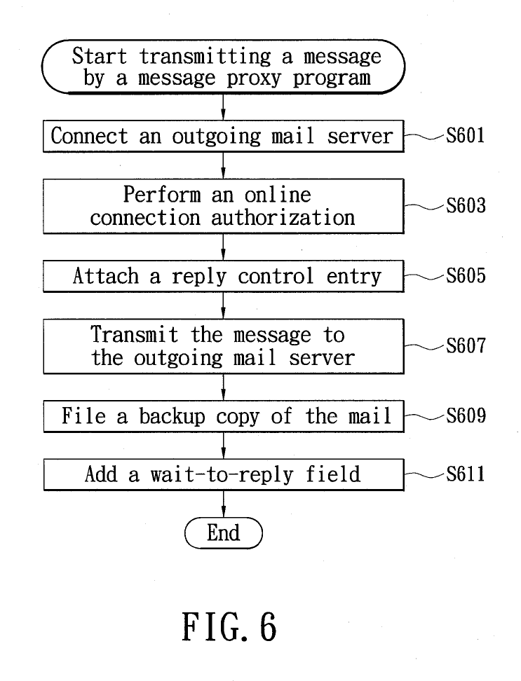

FIGS. 4A and 5B show the flow charts of a message reply system of the invention from the view point of the users, but the message agent itself actually transmits a message as shown in FIG. 6. At the beginning, the message agent connects to an outgoing mail server (first). If the message is transmitted by an e-mail, then it is necessary to connect to an outgoing mail server in compliance with the simple mail transfer protocol (SMTP) (Step S601), and may need to execute an online connection authorization to make sure that the sender has gone through the server authorization (Step S603), and then the message agent attaches a reply control entry to the message, and produces the record of a time to reply set by the sender, such that after the recipient's message is analyzed by the message agent, a reply reminder field is added to the message agent (Step S605). Then, the completed message is transmitted to the aforementioned outgoing mail server (first), and then transmitted to the recipient end through the server (Step S607). Now, the message agent at the sender end will file a backup copy of the transmitted message, such as a backup copy recorded in the sender's mail sending area as shown in FIG. 2A (Step S609), and then one or more wait-to-reply fields such as those recorded in the sender's mail receiving area as shown in FIG. 2A are added for waiting for a reply from the recipient within a deadline (Step S611).

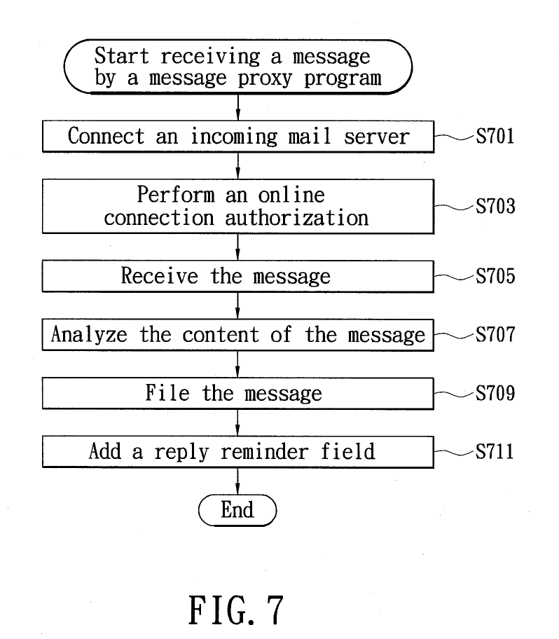

In the procedure at the receiving end as shown in FIG. 7, a message agent is used for receiving a message, and the message agent connects to an incoming server (second). If the message is transmitted by an e-mail, then the incoming mail server uses a general POP3 or an Internet Message Access Protocol (IMAP) incoming mail server (Step S701) to execute an online connection authorization for performing a user verification (Step S703). As the incoming mail server forwards the message, the message is received after the verification (Step S705), and after the message is received to the message agent, the message content is analyzed, and related information including the source and content of the message and whether or not the message reply mechanism such as the time to reply can be learned from the message (Step S707), and then the information in each field of the recipient's mail receiving area as shown in FIG. 2B is filed according to the analyzed message, such that the message is recorded in the message agent (Step S709). Since the required deadline of the reply can be found from the analyzed message, therefore a reply reminder field is added into the recipient's reply area as shown in FIG. 2B (Step S711) for performing a reply reminder at a specific time.

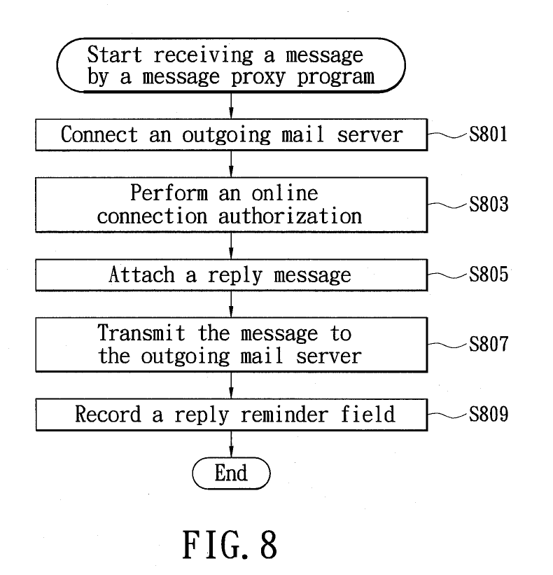

In the description above, the recipient records the received message in the message agent, and adds the reply reminder field at the same time for executing a reply message procedure to the message agent at the recipient end within a deadline (or after the expiration) as shown in FIG. 8.

The message agent connects to an outgoing mail server (second), wherein the outgoing mail server at the sender end is not necessary to be the same) (Step S801), and executes an online connection authorization. After the recipient end goes through the authorization, the message is transmitted (Step S803), but this step is not a must, and the outgoing mail server can verify the user by other methods or is opened directly to the connected users for transmitting messages. After the online connection authorization is completed, a reply message such as a message reply control entry is attached to notice the original sender that the message is the previous wait-to-reply message (Step S805), and then the reply message is transmitted to the outgoing mail server (Step S807), and the message agent records the reply reminder field automatically (Step S809).

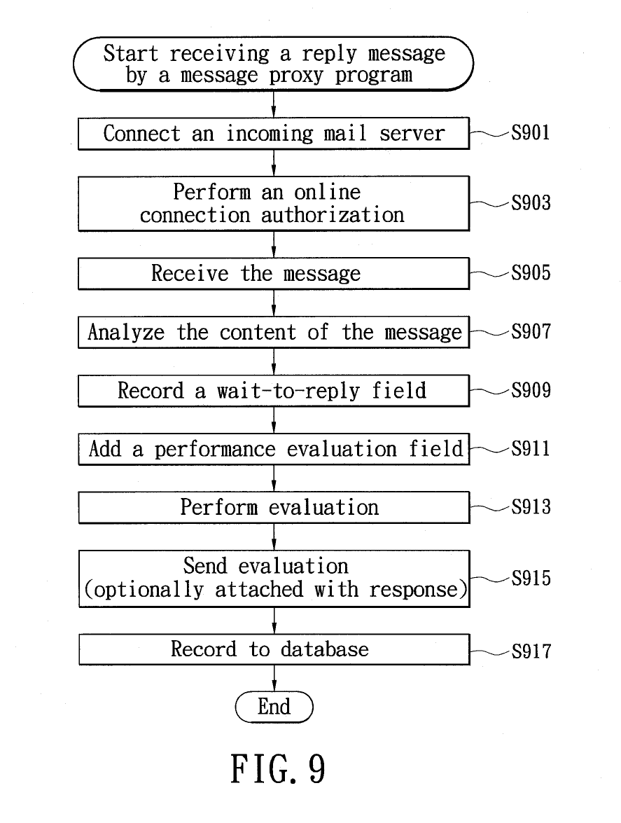

After the recipient has replied the message, the message agent of the message reply and performance evaluation system of the invention receives the reply message according to the procedure as shown in FIG. 9. The original sender uses the message agent to connect to an incoming mail server (first) wherein the incoming mail server at the recipient end is not necessary the same one such as a POP3 server or an IMAP server (Step S901), and then an online connection authorization is executed (Step S903), and the message is received after going through the verification (Step S905), and the content of the received message is analyzed (Step S907), and the information of the received message (such as the message reply control entry attached to the message) can be known from the message which is a message with a previously set time to reply, and recorded in the corresponding wait to reply field (Step S909). In step S911, a performance evaluation field is further added for the sender to perform evaluation (step S913). Then the evaluation is sent, optionally attached with response (step S915). The evaluation will be recorded to database (step S917) of future review.

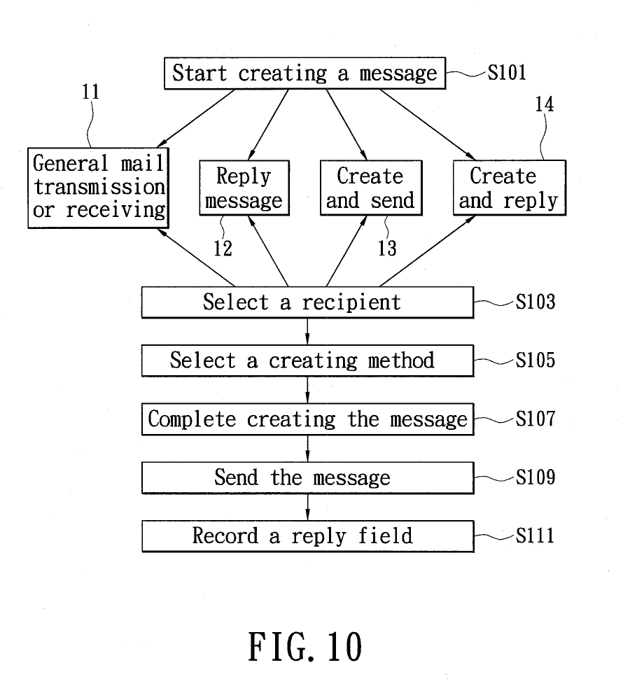

FIG. 10 shows a flow chart of a message reply system selecting a message creating method in accordance with the present invention. At the beginning, software and hardware for the message reply system of the invention are prepared (Step S101), wherein the software includes a message agent, and the hardware includes an audio/video preparing apparatus, a scanner, and a handwriting panel, etc, and the conditions for producing the message include a general transmission (11), which is a new message. There is a message reply (12), which is a message replied after the mail is received. There is another way of preparing and sending the message (13), wherein the already sent message can be sent once again such as forwarding to other recipients, or sending a complement to the recipient. There is another way of preparing a reply again (14), wherein the already replied message is prepared and replied to the original sender once again.

The recipient of the message is specified by selecting a recipient from a director as shown in FIG. 2D (Step S103), and then a creating method is selected (Step S105), wherein the preferred embodiments include the methods such as “scanned document or retrieved screen+audio/video+handwriting”, “scanned document or retrieved screen”, “text mail”, “audio/video mail”, “audio/video+handwriting mail”, “handwriting mail”, “captured scanned documents+audio/video+handwriting”, “successive retrieved screens+audio/video+handwriting” and “handwriting+audio/video mail”, etc.

After the creating method is selected, the message is produced step by step (Step S107), and each way of executing the corresponding application program such as an audio/video preparing program, a handwriting interface, a scanned document or retrieved screen program, and integrating the software and hardware to produce an audio/video multimedia or traditional text or a graphic message, and then such message is sent out (Step S109). In the meantime, the message is recorded in the reply field of the sender end or recipient end (Step S111), and the time to reply can be set if required.

In summation of the description above, the present invention is unlike the general software for transmitting messages. With the aforementioned technical contents, the software can actively divide the processed, non-processed, replied, non-replied messages, so as to achieve the purpose of tracing the progress or schedule of each delivered job. With the procedure of transmitting a message as shown in FIG. 6, the procedure of receiving the message as shown in FIG. 7, the procedure of replying the message as shown in FIG. 8, and the procedure of receiving a replied message as shown in FIG. 9, the message reply system and its method of the invention can be achieved, wherein the transmitted message includes a text, an audio/video message, a handwriting dynamic description, a graphic file or a scanned document or a retrieved screen, plus audio/video, handwriting, or captured scanned document, audio/video, handwriting, or successive retrieved screens, and audio/video, handwriting, etc.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A message reply and performance evaluation system, with a message reply mechanism incorporated into one mail user agent for a sender end and the other one mail user agent for a recipient end for adding a message reply control entry to transmit a message between the sender end and the recipient end, and the system comprising:
a mail server providing a mail transfer agent for establishing a mail service over a network;
a sender's personal computer at the sender end having a first mail user agent defining a sender's mail sending area and a sender's mail receiving area when interfacing with human operators at the sender end, wherein when the message is sent via the mail transfer agent, the first mail user agent adds one or more wait-to-reply fields that are displayed at first predetermined positions of an interface of the first mail user agent, and the wait-to-reply fields include a reply date/time, a respondent, a subject, a reply way and a performance evaluation field; and
a recipient's personal computer at the recipient end having a second mail user agent defining a recipient's mail receiving area and a recipient's reply area when interfacing with the human operators at the recipient end, wherein when the message is received via the mail transfer user agent, the recipient's reply area adds a reply reminder field that is displayed at a second predetermined position of an interface of the second mail user agent, wherein the reply reminder fields include a reply date/time, a respondent, a subject and a reply way;
thereby, after the recipient end replies a reply message via the second mail user agent, information associated with the reply message is recorded in the corresponding reply reminder fields; and after the sender end receives the reply message, the information associated with the reply message is recorded in the corresponding wait-to-reply fields, and a performance evaluation corresponding to the reply message is performed via the performance evaluation field.

2. The message reply and performance evaluation system of claim 1, wherein the message reply control entry comprises a time to reply, a reply address and a wait-to-reply/reply reminder field; and the message sent by the message agent comprises an audio/video document produced by an audio/video retrieving apparatus.

3. The message reply and performance evaluation system of claim 1, wherein the message sent by the message agent comprises a dynamic description produced by a handwriting system.

4. The message reply and performance evaluation system of claim 1, wherein the message sent by the message agent comprises a text, a scanned document, a retrieved screen, or a file, which further includes an audio/video document produced by an audio/video retrieving apparatus that is attached to the message, or a recorded dynamic description produced by a handwriting system.

5. The message reply and performance evaluation system of claim 1, wherein the reply message produced by the message agent comprises a text, a scanned document, a retrieved screen, or a file, which further includes an audio/video document produced by an audio/video retrieving apparatus that is attached to the message, or a recorded dynamic description produced by a handwriting system.

6. The message reply and performance evaluation system of claim 1, wherein the performance evaluation is attached with a note selected from a handwriting message, audio message, video message, text message or their combination.

7. The message reply and performance evaluation system of claim 1, wherein the message is created by a plurality of creating methods comprising creating a message through a scanned document or a retrieved screen, an audio/video message, a handwriting message, a pure text message, a message produced by capturing a plurality of scan records, a message produced by retrieving successive screens, or any combination of the above.

8. A message reply and performance evaluation method, comprising:
a message sending procedure, comprising:
connecting a sender's personal computer having a first mail user agent installed at a sender end to a first mail server;
adding a message reply control entry to a message transmitted by the first mail user agent;
storing a backup copy of the message; and
adding one or more wait-to-reply fields including a reply date/time, a respondent, a subject and a reply way;
a message receiving procedure, comprising:
connecting a recipient's personal computer having a second mail user agent at a recipient end to a second mail server connected to the first mail server;
parsing the message to locate a presence of the message reply control entry; and
adding one or more reply reminder fields including a reply date/time, a respondent, a subject and a reply way;
a message reply procedure, comprising:
connecting the second mail user agent to the second mail server; and
recording information associated with a reply message in the reply reminder fields; and
an acknowledge reply procedure, comprising:
connecting the first mail user agent to the first mail server;
parsing the reply message upon a receipt thereof; and
recording the information associated with the reply message in the wait-to-reply fields; and
a performance evaluation procedure, comprising:
receiving the reply message;
performing a performance evaluation;
sending the performance evaluation: and
recording the performance evaluation.

9. The message reply and performance evaluation method of claim 8, wherein the message reply control entry comprises a message time to reply, a reply address and a wait-to-reply/reply reminder field.

10. The message reply and performance evaluation method of claim 8, wherein the wait to reply field comprises a reply date/time, a respondent, a subject, a reply way and a performance evaluation field.

11. The message reply and performance evaluation method of claim 8, wherein the reply reminder field comprises a reply date/time, a respondent, a subject and a reply way.

12. The message reply and performance evaluation method of claim 8, wherein the message sent by the sender includes an audio/video document produced by an audio/video retrieving apparatus or a dynamic description produced by a handwriting system.

13. The message reply and performance evaluation method of claim 8, wherein the performance evaluation sent by the sender includes an audio/video document produced by an audio/video retrieving apparatus or a dynamic description produced by a handwriting system.

14. A message reply and performance evaluation method, comprising:
connecting to an incoming mail server;
performing an online connection authorization;
the incoming mail server forwarding a message sent by a sender with setting a reply time limit after authorization;
at the sender's side, adding a performance evaluation field within a wait-to-reply field of a message agent;
at the sender's side, performing a performance evaluation by means of the performance evaluation field; and
sending the performance evaluation.

15. The method of claim 14, wherein the message includes a text, a scanned document, a retrieved screen, or a file, which further includes an audio/video document produced by an audio/video retrieving apparatus that is attached to the message or a recorded dynamic description produced by a handwriting system.

16. The method of claim 14, wherein the performance evaluation is attached with a note made by an audio/video document produced by an audio/video retrieving apparatus, or a dynamic description produced by a handwriting system.

17. The method of claim 14, wherein before the reply time limit set to the message is met, a reply reminder at a recipient side is generated within a specific time according to the message of the wait-to-reply field.

18. The method of claim 14, wherein the performance evaluation is sent as the sender performs the performance evaluation after the reply time limit set to the message is met.

19. The method of claim 18, wherein the performance evaluation is replaceable, and is replaced by the later performance evaluation performed by the sender when a reply is received.

20. The method of claim 14, wherein the performance evaluation is sent after a reply is received from a recipient.
